(19) United States
(12) Patent Application Publication
(10) Pub. No.: US 2005/0123739 A1
(43) Pub. Date: Jun. 9, 2005

(54) Mesoporous silica/fluorinated polymer composite material

(76) Inventors: Yui Whei Chen-Yang, Hsinchu City (TW); Chih Wei Chen, Sansia Township (TW); Yao Zu Wu, Tainan City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/792,245

(22) Filed: Mar. 3, 2004

(30) Foreign Application Priority Data
Dec. 4, 2003 (TW) 92134139

(51) Int. Cl. C01B 33/36; B32B 3/26

(52) U.S. Cl. 428/306.6; 428/304.4; 428/307.3

(57) ABSTRACT

A mesoporous silica/fluorinated polymer composite material. Made up of hydrophobic modified mesoporous silica with a pore size of 0.1 to 50 nm and a fluorinated polymer, to provide Dk<4, Df<0.04, and CTE<60 ppm, the material is suitable for use in printed circuit boards or substrates in high frequency applications.

### BACKGROUND OF THE INVENTION

1. Field of the Invention

The present invention relates to a mesoporous silica/fluorinated polymer composite material, and in particular, to a mesoporous silica/fluorinated polymer composite material containing hydrophobic modified mesoporous silica.

2. Description of the Related Art

With the demands of high speed, wideband communications, electronic products are required to provide smaller, lighter, multifunctional characteristics causing electrical properties of printed circuit boards to encounter severe challenges. For example, in high speed calculation of high frequency applications, calculation frequencies reach hundreds MHz to even several GHz. In applications, such as simultaneous transmission of image and voice, required frequencies can reach up to 30 GHz. Japan Jisso Technology Road Map (1999), EIAJ reports that by 2010, Dk (dielectric constant) will be between 1.0 and 4.7, Df (dissipation factor) between 0.01 and 0.15, and CTE (coefficient of thermal expansion) between 3 and 60 ppm/° C. (10⁻⁶), as a necessity. Dk and Df correspond to signal transmission speed and transmission properties and must be small in high frequency applications. CTEs of substrate material and electronic elements are preferably the same. Too much difference will cause lifting between layers due to different thermal expansions of different working temperatures. Currently, most high frequency circuit boards use fluorinated substrate, such as, polytetrafluoroethylene (PTFE) substrate, which has a relatively low Dk (about 2.0) and Df (about 0.0004), but relatively high CTE (about 140 ppm/° C.). The CTE is reduced by the addition of fillers having a relatively low CTE in some technology.

It is known that the CTE of PTFE substrate is adjusted using silica as filler. However, silica has relatively high polarity and easily adsorbs water, requiring the outside surface of silica to be coated with a layer of hydrophobic silane. Furthermore, for the CTE of substrate to be similar to that of copper foil, added silica must be about 60% by weight. However, Dk of the substrate is responsively increased (to about 2.7 to 2.8) due to the higher Dk of silica (about 4), such that the application of the resulting substrate is limited.

U.S. Pat. No. 4,849,284 discloses an electronic substrate material containing PTFE as matrix and silica as filler to reduce CTE. When the filler amount is 63 to 71% by weight, Dk is between 2.64 and 2.83 and Df between 0.0022 and 0.0046. If the filler is coated with silane, Dk is between 2.76 and 2.91, Df is between 0.0016 and 0.0034, and the CTE is between 6 and 23 ppm/° C. In consideration of both Df and CTE, Dk of the resulting substrate material of this method is high, exceeding 2, and the use of mesoporous silica is not mentioned or suggested in the specification.

U.S. Pat. No. 5,149,590 discloses an electrical substrate material containing microfiber, in addition to silica and silane, to increase size stability after etching. A substrate having 63% by weight to 71% by weight of fillers is disclosed, resulting in Dk, Df, and CTE of 2.64 to 2.91, 0.0016 to 0.0046, and 6 to 23 ppm/° C., respectively. In consideration of both Df and CTE, Dk of the resulting substrate material of this method is high, exceeding 2, and the use of mesoporous silica is not mentioned or suggested.

Hence, there is a need for an improved material for application as a printed circuit board, especially for a high frequency substrate.

### SUMMARY OF THE INVENTION

Accordingly, an object of the invention is to provide a mesoporous silica/fluorinated polymer composite material having dielectric constant, dissipation factor, and coefficient of thermal expansion less than 4, 0.04, and 60 ppm/° C., respectively, suitable for application in a printed circuit board, especially for high frequency substrate.

The mesoporous silica/fluorinated polymer composite material of the present invention comprises 10 to 70 parts by weight of hydrophobic modified mesoporous silica having a pore size of 0.1 to 50 nm and 30 to 90 parts by weight of fluorinated polymer.

According to another feature of the present invention, the mesoporous silica/fluorinated polymer composite material comprises hydrophobic modified mesoporous silica having a pore size of 0.1 to 50 nm and fluorinated polymer in proportion such that the mesoporous silica/fluorinated polymer composite material has dielectric constant, dissipation factor, and coefficient of thermal expansion less than 4, 0.04, and 60 ppm/° C., respectively.

The Dk and Df of mesoporous silica/fluorinated polymer composite material of the present invention are sufficiently low as to meet the demands of small and light electronic products and high frequency applications. The CTE value can be appropriately adjusted depending on the metal foil material, solving the problem of lifting when working temperature changes and CTEs of substrate and metal foil or wires are different.

### BRIEF DESCRIPTION OF THE DRAWINGS

The present invention can be more fully understood by reading the subsequent detailed description and examples with references made to the accompanying drawings, wherein:

FIG. 1 shows the spectra from the Fourier transform infrared (FTIR) spectroscopy of the calcined (curve A) and then modified (curve B) mesoporous silica used in the example of the present invention;

FIG. 2 shows the X-ray diffraction patterns of the three stages of mesoporous silica (MCM-41): uncalcined (curve A), calcined (curve B), and modified (curve C) used in the example of the present invention;

FIG. 3a shows the nitrogen volume adsorbed by the calcined mesoporous silica and then modified mesoporous silica used in the example of the present invention and FIG. 3b shows the pore size distribution thereof.

FIGS. 4a and 4b show transmission electron microscopy of magnification of 300,000× and 200,000×, respectively, of the modified mesoporous silica used in the example of the present invention;

FIGS. 5a and 5b show scanning electron microscopy at magnification of 10,000× and 30,000×, respectively, of a cross section of a substrate without the addition of silica; and

FIGS. 5c and 5d show scanning electron microscopy at magnification of 10,000× and 30,000×, respectively, of a cross section of a substrate containing MCM-41 30% by weight.

### DETAILED DESCRIPTION OF THE INVENTION

The mesoporous silica/fluorinated polymer composite material of the present invention comprises any proportional constituency to attain the properties mentioned, preferably about 10 to 70 parts by weight, more preferably 20 to 60 parts by weight, and most preferably 30 to 50 parts by weight of hydrophobic modified mesoporous silica having a pore size of about 0.1 to 50 nm, and preferably about 30 to 90 parts by weight, more preferably 40 to 80 parts by weight, and most preferably 50 to 70 parts by weight of fluorinated polymer.

The hydrophobic modified mesoporous silica used in the present invention is formed from the hydrophobic modification of silica particles having a pore size of about 2 to 50 nm (referred to as mesoporous). The pore size is in the range of about 0.1 to 50 nm after modification, with shape not limited, being for example hexagonal or square. The arrangement of pores can be regular or irregular. The hydrophobic modified mesoporous silica can be irregular in shape, granular, or fibrous. The particle size can be 0.3 μm to 100 μm or other size, as long as the properties desired in the present invention are acheived.

The mesoporous silica described may be a commercial product or individually prepared. The preparation may refer to the process described in Microporous and Mesoporous materials, 48(2001), pp 127-137. The mesoporous silica may be prepared using various surfactants (cationic, ionic, nonionic, or amphoteric surfactant) as a template and silica source (such as tetraethoxysilane (TEOS), tetramethylsilane, methyltriethylsilane) in the presence of a co-solvent and removing the template to produce the desired product.

The surface of the mesoporous material must be modified to obtain a hydrophobic surface for reduced water adsorption, dielectric constant (Dk), and dissipation factor (Df). The modification may be chemical or physical.

The chemical method may comprise, for example, chemically bonding a hydrophobic modifier to the surface of mesoporous silica such that the hydrophobic modifier is grafted on the mesoporous silica surface to accomplish the modification. The mesoporous silica surface referred to herein includes surfaces outside and inside the pores. The hydrophobic modifier can comprise any hydrophobic modifier reacting with mesoporous silica, especially those having functional groups reacting with SiOH group on the silica surface to bond and achieve hydrophobic molecular moiety, such as silanes, halosilanes, haloalkanes, and the like. Silanes may comprise, for example, those having 1 to 3 of the same or different alkyl group(s), disilanes having 1 to 5 of the same or different alkyl group(s), trisilanes having 1 to 8 of the same or different alkyl group(s), and the like. Halosilanes may be, for example, those having 1 to 3 of the same or different alkyl group(s), halodisilanes having 1 to 5 of the same or different alkyl group(s), halotrisilanes having 1 to 8 of the same or different alkyl group(s), and the like, wherein each alkyl group may be substituted or unsubstituted aliphatic or aromatic alkyl, preferably having 1 to 10 carbons, such as, trimethylchlorosilane, isopropyldimethylchlorosilane, phenyldimethylchlorosilane, butyldimethylcholrosilane, 3,3,3-trifluoropropyltrichlorosilane, or 3,3,3-trifluoropropyl dimethylchlorosilane. Haloalkanes may be, for example, those having one or more carbon atoms, such as, chloromethane, bromomethane, chloroethane, bromoethane, iodoethane, iodopropane, iodoisopropane, and the like.

The physical method may comprise, for example, coating a hydrophobic modifier on the mesoporous silica surface. Useful hydrophobic modifiers include silanes and halosilanes. Silanes may be, for example, p-chlorotolyl trimethoxy silane, amino ethyl amino trimethoxy silane, phenyl trimethoxy silane, amino ethyl amino propyl trimethoxy silane, 3,3,3-trifluoropropyltrimethoxysilane, or combinations thereof, preferably amino ethyl amino trimethoxy silane, phenyl trimethoxy silane, amino ethyl amino propyl trimethoxy silane, 3,3,3-trifluoropropyltrimethoxysilane, and more preferably 3,3,3-trifluoropropyltrimethoxysilane. Halosilanes may be, for example, 3,3,3-trifluoropropyltrichlorosilane, 3,3,3-trifluoropropyldimethylchlorosilane, and the like.

The fluorinated polymer used in the present invention may be, for example, polytetrafluoroethylene, polyhexafluoropropene, copolymer of fluorinated monomer (such as, copolymer of fluoropropene, hexaflouropropene, and perfluoro alkyl vinyl ether), tetrafluoroethylene-hexafluoropropene copolymer, alkoxy fluoroethylene copolymer, ethylene-tetrafluoroethylene copolymer, and a combination thereof, preferably tetrafluoroethylene-hexafluoropropene copolymer, polytetrafluoroethylene or polyhexafluoropropene, and more preferably polytetrafluoroethylene or polyhexafluoropropene.

The mesoporous silica/fluorinated polymer composite material of the present invention is obtained by dispersing the hydrophobic modified mesoporous silica as fillers in fluorinated polymer. Preparation can be referred from U.S. Pat. No. 4,335,180.

The dielectric constant of air is 1, within the range of 1.0 to 4.7 of the dielectric constant desired for the substrates, and therefore air has no effect on the dielectric constant of the products and, in contrast, provides products with a lower dielectric constant than that obtained using conventional techniques. The air in the pores of the mesoporous silica/fluorinated polymer composite material of the present invention acts as a buffer media during thermal expansion of the composite material, such that the coefficient of thermal expansion of the composite material is reduced. Meanwhile, a relatively light electronic substrate can be obtained using hydrophobic mesoporous material as filler since the filler amount is reduced. Compared with conventional techniques, the coefficient of thermal expansion of the composite material of the present invention is reduced, as the dielectric constant is retained or even reduced and dissipation factor increases only slightly.

The mesoporous silica/fluorinated polymer composite material of the present invention may have a coefficient of thermal expansion of 5 to 120, and preferably 5 to 60, a dielectric constant of 1.4 to 4, and preferably 1.4 to 1.8, and a dissipation factor of 0.0008 to 0.04, and preferably 0.0008 to 0.005, making it suitable for use in circuit boards, especially high frequency substrates.

The coefficient of thermal expansion of the composite material can be measured using a thermo-mechanical analyzer (TMA) (TMA SS120, manufactured by Seiko Instrument company) with an expansion probe. The sample can be heated to 250° C. at a rate of 10° C./min. The coefficient of thermal expansion can be determined by the slope of the plot of the heat expansion v.s. The temperature. Dk and Df of the composite material can be measured using the Agilent E4991A impedance analyzer using AC impedance technique at 1 GHz.

The amount of mesoporous silica used in the present invention is adjustable to correspond to the material of metal foil or wire (such as, copper, or copper alloy, and the like), such that the CTE of the entire mesoporous silica/fluorinated polymer composite material is similar to that of wire material, solving the problem of lifting from undue difference in CTEs between wires and substrates, as encountered in conventional techniques. Generally, as the amount of mesoporous silica increases, the CTE of the substrate decreases.

The mesoporous silica/fluorinated polymer composite material may further contain inorganic materials such as microfiber, which may increase thermal stability during heating.

Preparation of Hydrophobic Modified Mesoporous Silica

CTMABr (cetyl-trimethyl-ammonium bromide) was dissolved in an NH₄OH aqueous solution while stirring. The TEOS was added to the above solution while stirring. The molar compositions of the reagents were CTMABr:TEOS:NH₄OH:H₂O=1.0:4.5:53.8:624.0. The resulting solution was heated at 90° C. for 24 hours. Finally, the solution containing suspended powder was filtered and washed extensively with deionized water. The powder obtained (referred as MCM-41) was calcined in air at 550° C. for 6 hours to remove the template. The prepared MCM-41 particles were dispersed in a dry toluene solution containing TMCS (trimethylchlorosilane)/HMDS (hexamethyldisilazane) (1:1 molar ratio), and refluxed for 48 hours at 60° C. The silylated silica, hydrophobic modified mesoporous silica, was then obtained by filtering off the solvent, washing consecutively with dry toluene and drying in an oven at 80° C. for 2 hours.

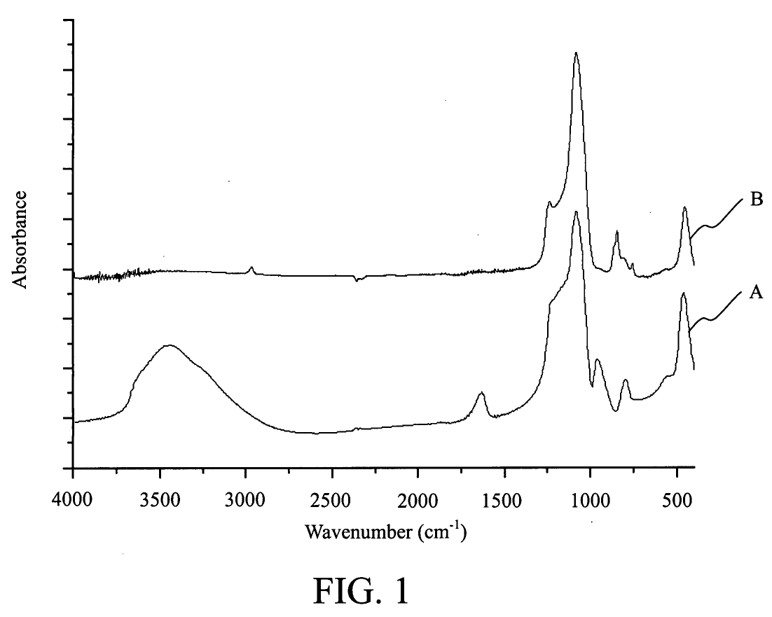

The mesoporous silica particles before and after the hydrophobic modification were tested for plane distance (d100), specific surface area (BET method) (S_{BTE}), pore volume, pore size, pore distance (A₀), and pore wall thickness, as shown in Table 1, and analyzed using FTIR spectroscopy, XRD, nitrogen adsorption and de-adsorption, and BJH pore distribution, with results shown in FIGS. 1, 2, 3a, and 3b, respectively.

TABLE 1

| | | | Pore | Pore | | Pore wall |
|---|---|---|---|---|---|---|
| | d(100) | S_{BTE} | volume | size | A₀ | thickness |
| | (Å) | (m²/g) | (cm³/g) | (Å) | (Å) | (Å) |
| Calcined | 40.3 | 924.0 | 0.8 | 27.0 | 46.5 | 19.5 |
| Calcined | 42.2 | 793.6 | 0.4 | 19.2 | 48.7 | 29.5 |
| and modified | | | | | | |

FIG. 1 shows a FTIR spectrum. Curve A shows the calcined but not modified mesoporous silica having specific peaks at 1100 cm^{-1, 800} cm⁻¹, and 460 cm⁻¹ for the vibration of Si—O, 960 cm⁻¹ for the vibration of Si—OH, and 1640 cm⁻¹ and 3400 cm⁻¹ for the vibration of H₂O adsorbed thereon. SiOH is polar and can adsorb large amounts of H₂O through hydrogen-bonding. Because water has a high dielectric constant, the substrate obtained from the calcined but not modified mesoporous silica possesses an increased dielectric constant and exhibits a defect in the circuit. Curve b shows significantly reduced peak intensity at 3400 cm⁻¹ for —OH in the calcined and modified mesoporous silica particles. The peaks at 847 cm⁻¹ and 2970 cm⁻¹ for the S₁—CH₃ and CH₃ indicate that the hydrophobic Si(CH₃)₃ group is effectively grafted onto the particle surface.

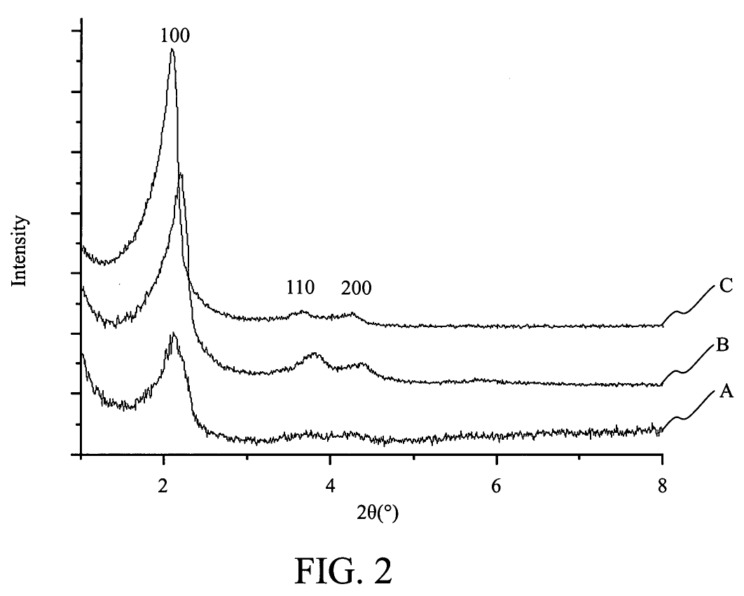

FIG. 2 shows X-ray diffraction patterns of mesoporous silica (MCM-41) at three stages: uncalcined (curve A), calcined (curve B), and then modified (curve C), to determine the pore arrangement structure. In FIG. 2, the patterns are very similar except that the positions and intensities of peaks vary slightly, indicating that the pore structure after modification is unchanged.

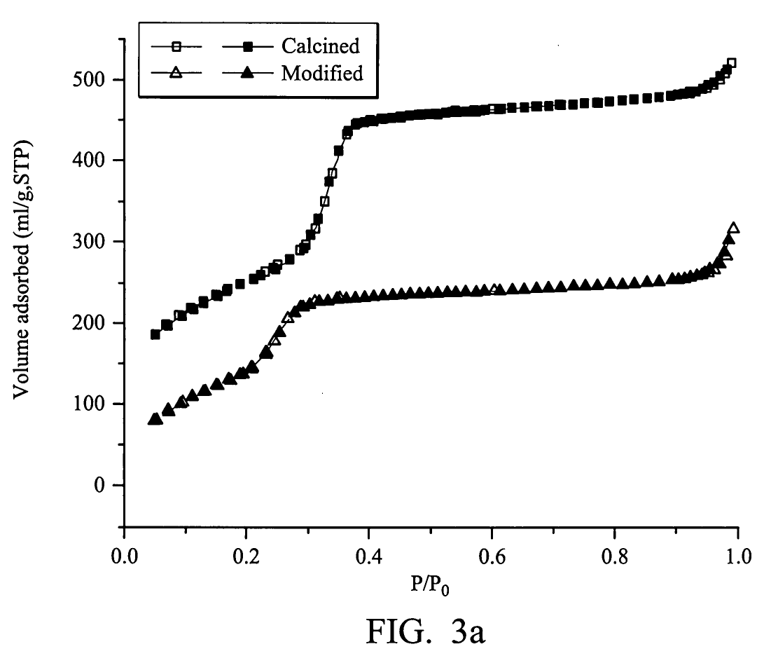

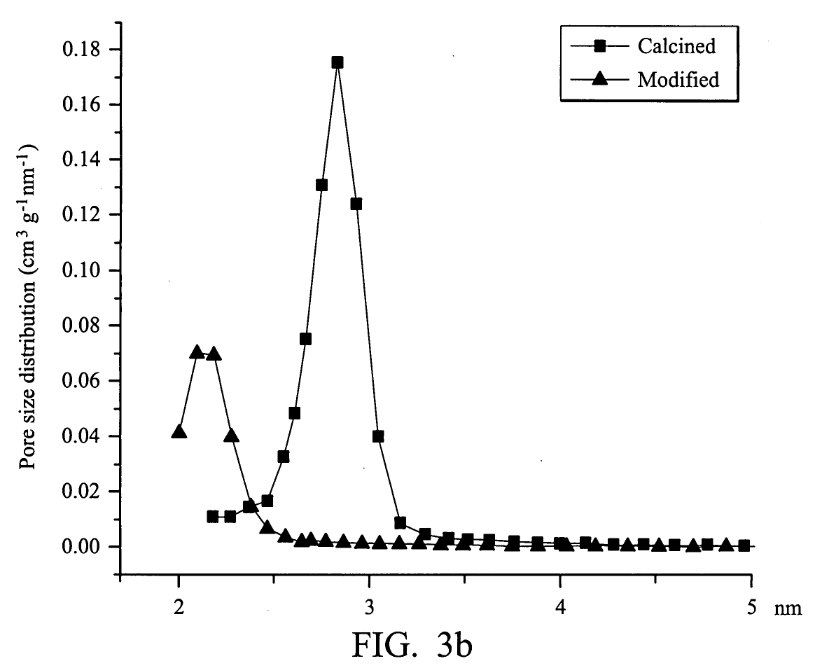

FIG. 3a shows the nitrogen volume adsorbed by the mesoporous silica before and after modification. FIG. 3b shows the BJH pore size distribution thereof. The resulting data is shown in Table 1. The adsorption-desorption curve is a type IV isotherm and the position of capillary condensation of the modified mesoporous silica particles is shifted to the left, indicating that the pore size is slightly reduced but pore structure is retained.

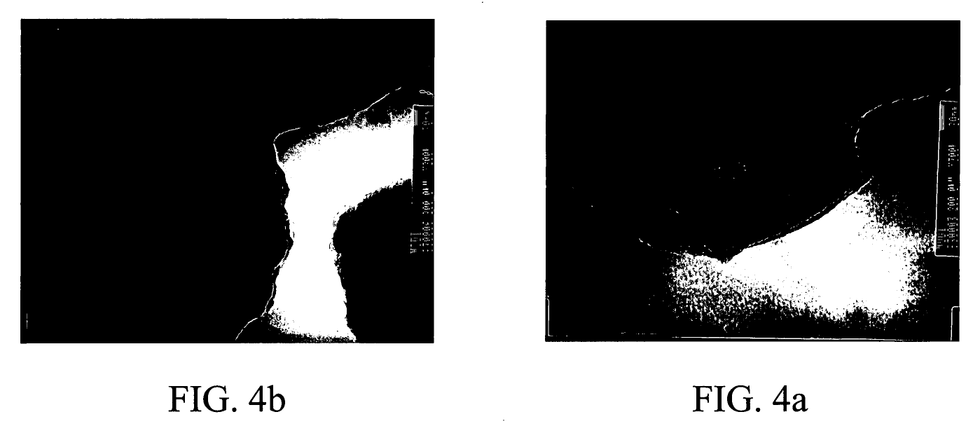

FIGS. 4a and 4b show transmission electron microscopy at magnification of 300,000× and 200,000×, respectively. The hexagonal pore structure is observable.

### EXAMPLE

The modified MCM-41 obtained in the Preparation was added to a PTFE emulsion prepared by emulsion polymerization of tetrafluoroethene monomer in the presence of perfluoroalkane carboxy salt emulsifying agent, in amounts of 0 (for comparison), 10, 20, 30, 40, and 50% by weight based on the total weight of MCM-41 and PTFE, to form a uniform mixture, respectively. After coagulation, the resultant was drained off the solvent (water) and dried in an oven at 130° C. to remove solvent, giving the mesoporous silica/fluorinated polymer composite material of the present invention.

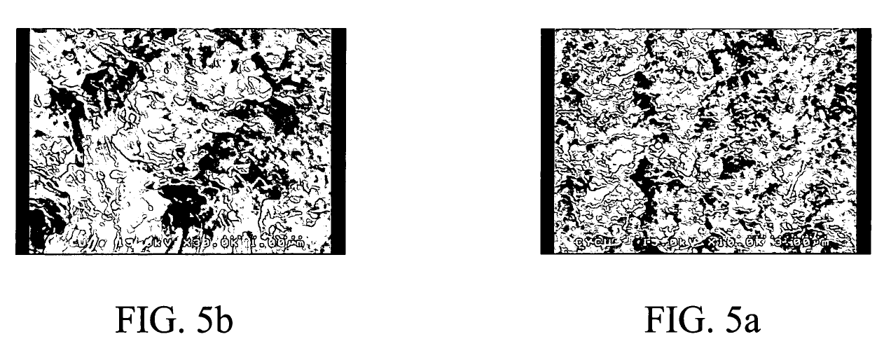

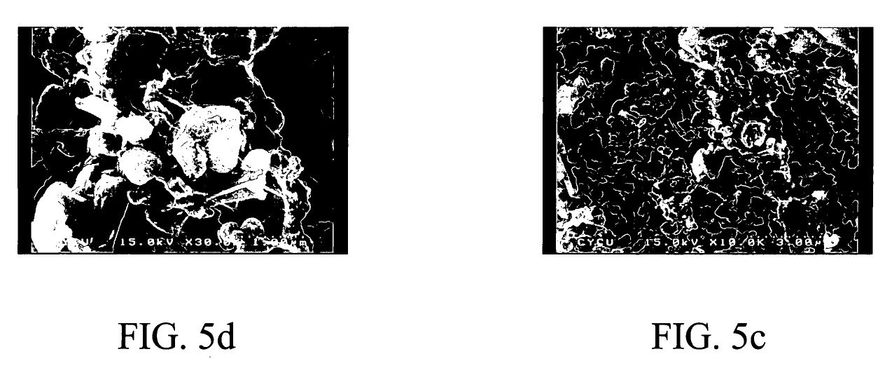

The composite material of the present invention was formed into a desired shape by calendaring, and sintered in an oven for 5 hours at 340° C. The resulting board was cut or trimmed to desired dimensions before measurement. The data is shown in Table 2. FIGS. 5a and 5b show scanning electron microscopy at magnification of 10,000× and 30,000×, respectively, of a cross section of a substrate without the addition of silica. FIGS. 5c and 5d show scanning electron microscopy at magnification of 10,000× and 30,000×, respectively, of a cross section of a substrate containing 30% by weight of MCM-41. It is clearly shown in FIGS. 5a and 5b that the silica particles disperse in fluorinated polymer.

TABLE 2

| | Pure | 10% | 20% | 30% | 40% | 50% |
|---|---|---|---|---|---|---|
| | PTFE | MCM-41 | MCM-41 | MCM-41 | MCM-41 | MCM-41 |
| Dk(1 GHz) | 2.05 | 2.02 | 2.06 | 1.94 | 1.70 | 1.85 |
| Df(1 GHz) | 0.0007 | 0.0008 | 0.0011 | 0.0049 | 0.0041 | 0.0092 |
| CTEz | 147.8 | 118.2 | 85.1 | 62.2 | 11.8 | NA¹ |
| (ppm/° C.) | | | | | | |

¹not test

As shown in Table 2, PTFE without the addition of fillers has a CTE_{z} (z: vertical direction) of 147.8 ppm/° C. With increase in added filler (that is, the hydrophobic modified mesoporous silica used in the present invention), the CTE is effectively reduced, to be 11.8 ppm/° C. when the added of filler is 40% by weight, indicating that the mesopore properties play a role as a buffer during heat expansion.

The relationship of filler amount to Dk and Df is also shown in Table 2. Dk and Df of PTFE substrate are 2.05 and 0.0007, respectively and PTFE itself is known to be the non-porous material with the lowest Dk and Df. With respect to printed circuit boards, a lower Dk effectively reduces propagation delay and crosstalk. In the present invention, Dk is effectively reduced to 1.70 by the addition of mesoporous silica filler, solving the problem. A lower Df reduces rise time degradation. For high frequency substrates, Df is preferred less than 0.004, a feature achieved by the present invention.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A mesoporous silica/fluorinated polymer composite material, comprising:
10 to 70 parts by weight of hydrophobic modified mesoporous silica having a pore size of 0.1 to 50 nm, and
30 to 90 parts by weight of fluorinated polymer.

2. The composite material as claimed in claim 1, wherein the surface of the hydrophobic modified mesoporous silica is chemically hydrophobically modified.

3. The composite material as claimed in claim 2, wherein the surface of the hydrophobic modified mesoporous silica is chemically bonded to a hydrophobic modifier.

4. The composite material as claimed in claim 3, wherein the hydrophobic modifier is hydrophobic silane, halosilane, haloalkane, or a combination thereof.

5. The composite material as claimed in claim 1, wherein the surface of the hydrophobic modified mesoporous silica is physically hydrophobically modified.

6. The composite material as claimed in claim 5, wherein the hydrophobic modified mesoporous silica is coated with a hydrophobic modifier.

7. The composite material as claimed in claim 6, wherein the hydrophobic modifier is silane, halosilane, haloalkane, or a combination thereof.

8. The composite material as claimed in claim 7, wherein the silane is p-chlorotolyl trimethoxy silane, amino ethyl amino trimethoxy silane, phenyl trimethoxy silane, amino ethyl amino propyl trimethoxy silane, 3,3,3-trifluoropropyltrimethoxysilane), or a combination thereof.

9. The composite material as claimed in claim 1, wherein the fluorinated polymer is polytetrafluoroethylene, polyhexafluoropropene, tetrafluoroethylene-hexafluoropropene copolymer, alkoxy fluoroethylene copolymer, ethylene-tetrafluoroethylene copolymer, or a combination thereof.

10. The composite material as claimed in claim 1, wherein the pore of the hydrophobic modified mesoporous silica is square or hexagonal.

11. The composite material as claimed in claim 10, wherein the pore of the hydrophobic modified mesoporous silica is regularly arranged.

12. The composite material as claimed in claim 10, wherein the pore of the hydrophobic modified mesoporous silica is irregularly arranged.

13. The composite material as claimed in claim 1, wherein the hydrophobic modified mesoporous silica is granular.

14. The composite material as claimed in claim 1, wherein the hydrophobic modified mesoporous silica is fibrous.

15. A mesoporous silica/fluorinated polymer composite material, comprising hydrophobic modified mesoporous silica having a pore size of 0.1 to 50 nm and fluorinated polymer in proportion such that the mesoporous silica/fluorinated polymer composite material has dielectric constant, dissipation factor, and coefficient of thermal expansion less than 4, 0.04, and 60 ppm/° C., respectively.

16. The composite material as claimed in claim 15, wherein the surface of the hydrophobic modified mesoporous silica is chemically hydrophobically modified.

17. The composite material as claimed in claim 16, wherein the surface of the hydrophobic modified mesoporous silica is chemically bonded to a hydrophobic modifier.

18. The composite material as claimed in claim 17, wherein the hydrophobic modifier is hydrophobic silane, halosilane, haloalkane, or a combination thereof.

19. The composite material as claimed in claim 15, wherein the surface of the hydrophobic modified mesoporous silica is physically hydrophobically modified.

20. The composite material as claimed in claim 19, wherein the hydrophobic modified mesoporous silica is coated with a hydrophobic modifier.

21. The composite material as claimed in claim 20, wherein the hydrophobic modifier is silane, halosilane, haloalkane, or a combination thereof.

22. The composite material as claimed in claim 21, wherein the silane is p-chlorotolyl trimethoxy silane, amino ethyl amino trimethoxy silane, phenyl trimethoxy silane, amino ethyl amino propyl trimethoxy silane, 3,3,3-trifluoropropyltrimethoxysilane, or a combination thereof.

23. The composite material as claimed in claim 15, wherein the fluorinated polymer is polytetrafluoroethylene, polyhexafluoropropene, tetrafluoroethylene-hexafluoropropene copolymer, alkoxy fluoroethylene copolymer, ethylene-tetrafluoroethylene copolymer, or a combination thereof.

24. The composite material as claimed in claim 15, wherein the pore of the hydrophobic modified mesoporous silica is square or hexagonal.

25. The composite material as claimed in claim 24, wherein the pore of the hydrophobic modified mesoporous silica is regularly arranged.

26. The composite material as claimed in claim 24, wherein the pore of the hydrophobic modified mesoporous silica is irregularly arranged.

27. The composite material as claimed in claim 15, wherein the hydrophobic modified mesoporous silica is granular.

28. The composite material as claimed in claim 15, wherein the hydrophobic modified mesoporous silica is fibrous.
